(19) United States
(12) Patent Application Publication
(10) Pub. No.: US 2014/0257899 A1
(43) Pub. Date: Sep. 11, 2014

(54) TASK DELEGATION SYSTEM THAT TRANSPARENTLY AND CONSTRUCTIVELY REWARDS TIMELY AND ACCURATE COMPLETION OF TASKS TO INCREASE PRODUCTIVITY AND MORALE OF WORKERS

(71) Applicant: NOEL PENG, Plano, TX (US)

(72) Inventor: NOEL PENG, Plano, TX (US)

(21) Appl. No.: 14/197,115

(22) Filed: Mar. 4, 2014

Related U.S. Application Data
(60) Provisional application No. 61/773,583, filed on Mar. 6, 2013.

(51) Int. Cl. G06Q 10/06

(52) U.S. Cl. CPC G06Q 10/063114; G06Q 10/06398
USPC 705/7.15

(57) ABSTRACT

A system is disclosed to increase productivity and morale by delegating clearly defined tasks and rewarding timely completion of tasks positively with points/scores/advancements, which is constructive and transparent. In some embodiments, the system creates a rewarding, friendly competitive, and fun environment and culture to encourage timely completion of tasks with constructive, transparent feedback.

### CLAIM OF BENEFIT TO PRIOR APPLICATION

This application claims benefit to U.S. Provisional Patent Application 61/773,583, entitled “A system to increase productivity and morale by delegating clearly defined tasks and rewarding timely completion of tasks positively with points/scores/advancements, which are constructive and transparent,” filed Mar. 6, 2013. The U.S. Provisional Patent Application 61/773,583 is incorporated herein by reference.

### BACKGROUND

Embodiments of the invention described in this specification relate generally to productivity systems, and more particularly, to task delegation and reward systems for increasing productivity and morale.

People have a tendency to procrastinate, forget about their responsibilities, or often are not sure about the details of their responsibilities even with supervision.

Past systems did not reward timely completion of tasks positively with points/scores/advancements, which are constructive and transparent.

Therefore, what is needed is a way to encourage timely completion of tasks with constructive, transparent feedback in a rewarding, friendly competitive, and fun environment/culture.

### BRIEF DESCRIPTION

Some embodiments of the invention include novel systems and methods for delegating tasks in a way that increases productivity and morale of workers. In some embodiments, a method for delegating tasks includes transparently and constructively rewarding timely completion of tasks to increase the productivity and the morale of the workers. In some embodiments, the method rewards the timely completion of a set of tasks delegated to a worker by reinforcing a positive work environment and culture. In some embodiments, the method positively reinforces the work environment and culture by awarding task completion points, scores, or advancements.

In some embodiments, a task delegation system includes a set of timers and a task completion value system that is transparent for all workers to review. The task completion value system includes a point system, a scoring system, or an advancement system.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a schematic view of a task delegation system the performs a process in some embodiments for transparently and constructively rewarding timely completion of tasks to increase productively and morale of workers.

FIG. 2 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include novel systems and methods for delegating tasks in a way that increases productivity and morale of workers. In some embodiments, a method for delegating tasks includes transparently and constructively rewarding timely completion of tasks to increase the productivity and the morale of the workers. In some embodiments, the method rewards the timely completion of a set of tasks delegated to a worker by reinforcing a positive work environment and culture. In some embodiments, the method positively reinforces the work environment and culture by awarding task completion value indicators to workers who complete tasks on time. The task completion value indicators include one or more of points, scores, and advancements.

In some embodiments, a task delegation system includes a set of timers and a task completion value system that is transparent for all workers to review. In some embodiments, the task completion value system includes one or more of a point system, a scoring system, and a merit-based advancement system. The system of some embodiments includes a set of timers that allows tasks to be clearly delegated and worked on during a specific time period for completion. In some embodiments, the system increases productivity and morale by delegating the clearly defined tasks with the timers. In some embodiments, the timers automatically and constantly remind workers about the tasks, thereby allowing for the rewarding of accurately and timely completed tasks positively with points/scores/advancements, which are constructive and transparent.

The embodiments described in this specification differ from and improve upon currently existing options. In particular, some embodiments differ by the manner in which tasks are clearly defined to increase productivity and morale of workers. In addition to delegating clearly defined tasks, the system of some embodiments automatically and constantly reminds, with timers, workers assigned to complete tasks about the tasks. The system also rewards accurate and timely completion of tasks positively with rewards. Examples of rewards that are used include points awarded in a point system, scores tallied in a scoring system, and advancements earned in a merit-based advancement system. These positive rewards are also constructive and transparent.

The system improves upon past systems which have not provided rewarding, friendly competitive, and fun environments and/or cultures in order to encourage timely completion of tasks with constructive, transparent feedback. In contrast, the system creates a rewarding, friendly competitive, and fun environment and culture to encourage timely completion of tasks with constructive, transparent feedback.

The system can be used in any field that requires positive, productive behaviors and to maintain positive, productive behaviors in a rewarding, friendly competitive, and fun environment and culture either with a computer or machine. It can be an addition or a part of a larger system that is accessible by everyone from families to corporations.

The system of the present disclosure may be comprised of the following elements. This list of possible constituent elements is intended to be exemplary only and it is not intended that this list be used to limit the system of the present application to just these elements. Persons having ordinary skill in the art relevant to the present disclosure may understand there to be equivalent elements that may be substituted within the present disclosure without changing the essential function or operation of the system.

1. A program to assign clearly defined task.

2. To assign timers for completion of each task.

3. To acknowledge receipt and understanding of the details of each task.

4. Once each task is complete, to allow verification of accurate completion.

5. Once accurate task completion is submitted and verified in a timely fashion, reward positively with points/scores/advancements swiftly.

6. If task is not completed accurately in a timely fashion, reprimand with less points/scores, no points/scores, or negative points/scores swiftly. Assign the clearly defined task with increased value to another peer in some embodiments. This will encourage accurate completion of task in a timely fashion by a different peer.

7. To create a rewarding, friendly competitive, and fun environment and culture to encourage timely completion of tasks with constructive, transparent feedback.

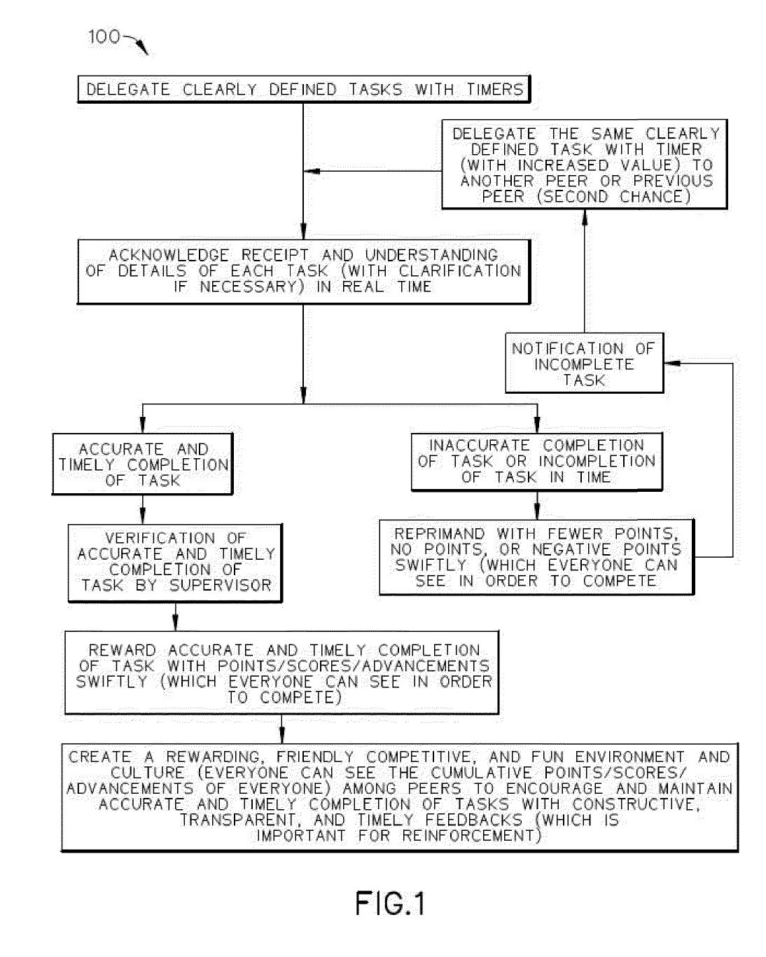

By way of example, FIG. 1 conceptually illustrates a schematic view of a task delegation system that performs a process in some embodiments for transparently and constructively rewarding timely completion of tasks to increase productively and morale of workers. As shown in this figure, a process 100 is performed by the task delegation system. In this example, the process 100 includes delegating clearly defined tasks with timers, acknowledging receipt and understanding of details of each task in real time (clarifications made as needed), and then a determination of whether or not a task has been timely and accurately completed. In some embodiment, when the process 100 determines that the task has been accurately and timely completed, the system starts to perform verification of the accuracy and timeliness of the task completion. In some embodiments, a supervisor authenticates and verifies the results. When verification is complete, the process 100 then rewards the accurate and timely completion of the task with points, scores, and/or advancements. This is done swiftly to produce a positive effect on the worker who completed the task. This is also done transparently for all workers to see, thereby allowing all the workers of a team or group to compete with each other. In essence, the process 100 creates a rewarding, friendly competitive, and fun environment and/or culture by the steps above. Since the process is transparent and competitive, all of the workers are able to gauge their productivity against peers, allowing for constructive encouragement to complete tasks accurately and timely.

On the other hand, when the process 100 determines that the task was inaccurately completed or not completed in the specified time period, the process then reprimands by decreasing points, giving no points, giving negative points, etc. This is done swiftly to encourage increased productivity and not to delay re-assignment of the task. This is also done transparently for all workers on the team or in the group to see. The process 100 next notifies of the incomplete/inaccurate task, thereby allowing re-assignment of the task to occur. The process then re-delegates the same clearly defined task with associated timer to another peer for completion. In some embodiments, the rewarded value is increased (i.e., more points, higher scoring, better advancements, etc.). In some embodiments, the worker who failed to timely and/or accurately complete the assigned task will be re-assigned for another try at completing the task. Then the process 100 transitions back to the step of acknowledging receipt and understanding of task details.

The various elements of the system of the present disclosure as presented in the figures and in this Specification may be related in the following exemplary fashion. It is not intended to limit the scope or nature of the relationships between the various elements and the following examples are presented as illustrative examples only. (1) and (2) assign clearly defined tasks with completion timers. (3) acknowledges receipt of each task. Reward positively with points/scores/advancements swiftly only when (4) and (5) are completed accurately in a timely fashion. If (4) and (5) are not completed accurately in a timely fashion, reprimand with points/scores swiftly. (6) If task is not completed accurately in a timely fashion, reprimand with points/scores swiftly. Assign the clearly defined task with increased value to another peer. This will encourage accurate completion of task in a timely fashion by a different peer. (7) To create a rewarding, friendly competitive, and fun environment and culture to encourage timely completion of tasks with constructive, transparent feedback.

The system of the present disclosure generally works by way of a program that (1) assigns clearly defined tasks, (2) assigns timers for completion of each task (3) acknowledges receipt of each task (4) verifies or allows for verification of accurate completion of each task once the task is complete (5) rewards positively and swiftly, once accurate task completion is submitted and verified in a timely fashion, the rewards being one or more of points, scores, or advancements (6) reprimands poor productivity if a task is not completed accurately in a timely fashion by decreasing points or scores or removing prior advancements swiftly, and then re-assigns the clearly defined task with increased value to another peer, thereby encouraging accurate completion of tasks in a timely fashion by a different peer, and (7) creating a rewarding, friendly competitive, and fun environment and culture to encourage timely completion of tasks with constructive, transparent feedback by only rewarding positively with points/scores/advancements when (4) and (5) are completed accurately in a timely fashion, and reprimanding if (4) and (5) are not completed accurately in a timely fashion by swiftly decreasing points or scores or removing advancements.

To make the system of the present disclosure, a person would craft software that is able to complete the requisite tasks and provide the users with the useful tools described here above. In standard practice, all elements work to help encourage positive, productive behaviors and maintain positive, productive behaviors in a rewarding, friendly competitive, and fun environment and culture. In some embodiments, steps (5) and (6) are applied independently for each task.

Additionally, some embodiments of the task delegation system can be used in any field that requires positive, productive behaviors and to maintain positive, productive behaviors in a rewarding, friendly competitive, and fun environment and culture either with a computer or machine. The task delegation system can be an addition or a part of a larger system that is accessible by everyone from families to corporations.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

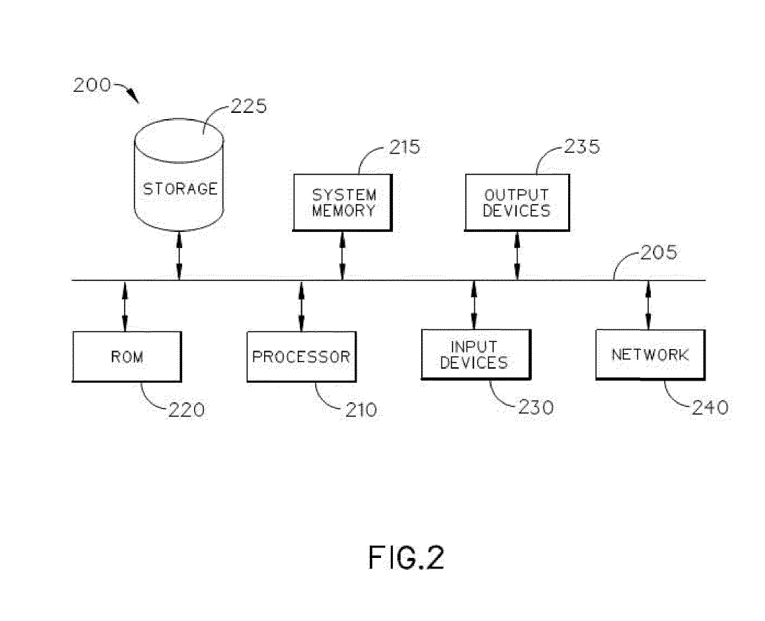

FIG. 2 conceptually illustrates an electronic system 200 with which some embodiments of the invention are implemented. The electronic system 200 may be a computer, phone, PDA, or any other sort of electronic device. Such an electronic system includes various types of computer readable media and interfaces for various other types of computer readable media. Electronic system 200 includes a bus 205, processing unit(s) 210, a system memory 215, a read-only 220, a permanent storage device 225, input devices 230, output devices 235, and a network 240.

The bus 205 collectively represents all system, peripheral, and chipset buses that communicatively connect the numerous internal devices of the electronic system 200. For instance, the bus 205 communicatively connects the processing unit(s) 210 with the read-only 220, the system memory 215, and the permanent storage device 225.

From these various memory units, the processing unit(s) 210 retrieves instructions to execute and data to process in order to execute the processes of the invention. The processing unit(s) may be a single processor or a multi-core processor in different embodiments.

The read-only-memory (ROM) 220 stores static data and instructions that are needed by the processing unit(s) 210 and other modules of the electronic system. The permanent storage device 225, on the other hand, is a read-and-write memory device. This device is a non-volatile memory unit that stores instructions and data even when the electronic system 200 is off. Some embodiments of the invention use a mass-storage device (such as a magnetic or optical disk and its corresponding disk drive) as the permanent storage device 225.

Other embodiments use a removable storage device (such as a floppy disk or a flash drive) as the permanent storage device 225. Like the permanent storage device 225, the system memory 215 is a read-and-write memory device. However, unlike storage device 225, the system memory 215 is a volatile read-and-write memory, such as a random access memory. The system memory 215 stores some of the instructions and data that the processor needs at runtime. In some embodiments, the invention's processes are stored in the system memory 215, the permanent storage device 225, and/or the read-only 220. For example, the various memory units include instructions for processing appearance alterations of displayable characters in accordance with some embodiments. From these various memory units, the processing unit(s) 210 retrieves instructions to execute and data to process in order to execute the processes of some embodiments.

The bus 205 also connects to the input and output devices 230 and 235. The input devices enable the user to communicate information and select commands to the electronic system. The input devices 230 include alphanumeric keyboards and pointing devices (also called “cursor control devices”). The output devices 235 display images generated by the electronic system 200. The output devices 235 include printers and display devices, such as cathode ray tubes (CRT) or liquid crystal displays (LCD). Some embodiments include devices such as a touchscreen that functions as both input and output devices.

Finally, as shown in FIG. 2, bus 205 also couples electronic system 200 to a network 240 through a network adapter (not shown). In this manner, the computer can be a part of a network of computers (such as a local area network (“LAN”), a wide area network (“WAN”), or an intranet), or a network of networks (such as the Internet). Any or all components of electronic system 200 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIG. 1 conceptually illustrates a schematic of a task delegation system that performs a process for transparently and constructively rewarding timely completion of tasks to increase productively and morale of workers. The specific operations of the process 100 may not be performed in the exact order shown and described. Specific operations may not be performed in one continuous series of operations, and different specific operations may be performed in different embodiments. Furthermore, the process 100 could be implemented using several sub-processes, or as part of a larger macro process. Thus, one of ordinary skill in the art would understand that the invention is not to be limited by the foregoing illustrative details, but rather is to be defined by the appended claims.

We claim:

1. A task delegation system that increases productivity and morale of workers, the task delegation system comprising:
a task assignment program for assigning a set of tasks to a set of workers on a team, each task associated with a clearly defined time period for accurate completion of the task;
a set of timers associated with the set of tasks, wherein each timer provides a set of reminders regarding the timely completion of the task, each reminder provided to the worker assigned to a complete the associated task;
a verification system that evaluates the timeliness and accuracy of each completed task, wherein (i) when a task is timely and accurately completed the verification system rewards the worker who was assigned to complete the task and (ii) when the task is at least one of not completed timely and not completed accurately, the verification system reprimands the worker who was assigned to complete the task; and
a positive encouragement system that swiftly (i) rewards workers with at least one of points, scores, and advancements for each timely and accurately completed task and (ii) reprimands workers with at least one of fewer points, no points, and negative points for each task that is not completed timely and accurately.

2. The task delegation system of claim 1, wherein the positive encouragement system is a transparent system in which all workers can review the status of any delegated task.

3. The task delegation system of claim 1, wherein the assignment program delegates a previously-delegated task that was not completed timely and accurately.

4. The task delegation system of claim 3, wherein the assignment program delegates the previously-delegated task to one of another peer and a previous peer.

5. The task delegation system of claim 4, wherein the assignment program delegates the previously-delegated task to another peer with an increased value.

6. The task delegation system of claim 4, wherein the assignment program delegates the previously-delegated task to the previous peer with one of an equivalent value and a decreased value.

7. A non-transitory computer readable medium storing a program which when executed by at least one processing unit of a computing device rewards the timely and accurate completion of delegated tasks to increase productivity and morale of workers, said program comprising sets of instructions for:
delegating a clearly defined task to a particular worker in a set of team workers;
associating a timer with the delegated task, said timer defining a completion time by which the task is to be accurately completed by the worker;
performing one of a task reward evaluation and a task reprimand evaluation based on an accuracy and timeliness determination for the task, wherein the task reward evaluation is performed when the task is accurately completed by the worker within the defined completion time and the task reprimand evaluation is performed when the task is at least one of not accurately completed and not completed within the defined completion time;
rewarding the worker when the task reward evaluation is performed; and
reprimanding the worker when the task reprimand evaluation is performed.

8. The non-transitory computer readable medium of claim 7, wherein the program further comprises a set of instructions for posting rewards and reprimands of all workers associated with all tasks on a display that is accessible to all workers of the team.

9. The non-transitory computer readable medium of claim 7, wherein the set of instructions for rewarding the worker comprises a set of instructions for positively awarding the worker with one of a score, a set of points, and an advancement.

10. The non-transitory computer readable medium of claim 7, wherein the set of instructions for reprimanding the worker comprises a set of instructions for swiftly reprimanding the worker with one a set of negative points, an empty set of no points, and a set of reduced points.
